(19) United States
(12) Patent Application Publication
(10) Pub. No.: US 2003/0189825 A1
(43) Pub. Date: Oct. 9, 2003

(54) Decorative electronic lighting for Halloween pumpkin

(76) Inventors: Eric D. Tauch, Plano, TX (US); John K. Tauch, Plano, TX (US)

Correspondence Address: ERIC D. TAUCH, 2901 LOFTSMOOR LANE, PLANO, TX, 75025, US

(21) Appl. No.: 10/063,252

(22) Filed: Apr. 3, 2002

(51) Int. Cl. F21S 6/00

(52) U.S. Cl. 362/122; 362/800; 362/231; 362/259

(57) ABSTRACT

A decorative electronic lighting apparatus is used to illuminate the interior of a Halloween pumpkin in place of the more traditional burning candle. This apparatus is comprised of an array of multi-color light emitting diodes (LED), micro-controller, and accompanying LED control software. This software sequences the LED devices at various intensity levels, on/off duration, and color combinations so as to produce a multitude of light effects.

### TECHNICAL FIELD AND BACKGROUND OF INVENTION

This invention relates to the field of seasonal decorations, and is an electronic lighting apparatus for a Halloween pumpkin. Traditionally, at Halloween, pumpkins are cleaned out and the remaining shell carved with a pattern which might include a scary face or other Halloween depiction. A burning candle is then used to illuminate the interior of the pumpkin, allowing light to shine through the carved pattern. These carved pumpkin decorations are displayed on the night of Halloween and/or for several nights before.

Although a burning candle is traditionally used to illuminate Halloween pumpkins, electronic lighting has become popular for added safety and convenience. Most of these lighting systems utilize incandescent bulbs with no or very primitive lighting control, and a battery source for power. Systems which have been observed include arrays of flashing incandescent (Christmas) bulbs or a single artificial candle with a white incandescent bulb at the top of the candle. These systems incorporate minimal electronic control of the light source. For example one product utilizes 5 incandescent flashing bulbs (random flash due to thermal contact in bulb) and two “C” cell batteries. This product provides for approximately 3 hours of battery operation.

### SUMMARY OF INVENTION

This embodiment of the invention improves on current holiday decorative lighting devices by utilizing an electronic control (micro-controller) and solid-state light emitting diode (LED) illumination in place of incandescent light bulbs. Electronic control of the lighting allows for the creation of many illumination effects, and the preferred use of LED devices in place of incandescent bulbs provides for improved battery life (longer duration of operation, typically ten times an equivalent incandescent bulb implementation). Other devices of illumination could be implemented, such as incandescent bulbs, neon bulbs, florescent bulbs, or laser.

An array of multi-colored LED devices can be utilized; LED quantities and colors are dependent on the colors and the amount of light intensity required for the desired light effect. Typical LED colors which are available are red, green, yellow, orange, blue, and white. LED devices are also generally classified as standard or “super-bright” and reflect the illumination efficiency at which the device operates (“super-bright” emits much more light energy per unit of electrical current).

LED devices in desired colors are mounted on a printed circuit board, along with the electronic control and a battery housing. Finally, the complete printed circuit board is placed in an enclosure.

### BRIEF DESCRIPTION OF DRAWINGS

FIGS. 1A and 1B are diagrams which show how the invention is to be used. These diagrams show the scale of the invention and how it can be placed in a pumpkin.

FIG. 2 is a block diagram of the electronic design.

FIG. 3 is a timing diagram which shows how LED devices are pulse width modulated (PWM) by the micro-controller.

FIG. 4 is a state table which shows the five possible software states of each LED.

FIG. 5 is an exploded perspective view which shows the three physical components of the invention. These are: plastic housing, printed circuit board (PCB), and battery holder.

FIG. 6 is a layout plot of the printed circuit board and components.

FIGS. 7A, 7B, 7C, and 7D are four way perspective views of the assembled invention.

### DETAILED DESCRIPTION

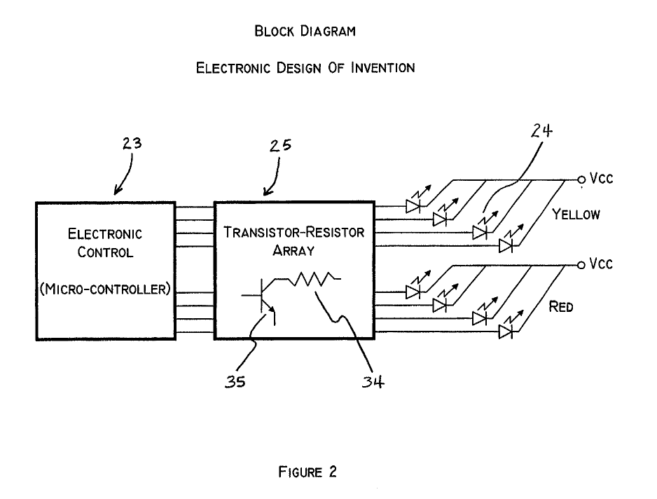

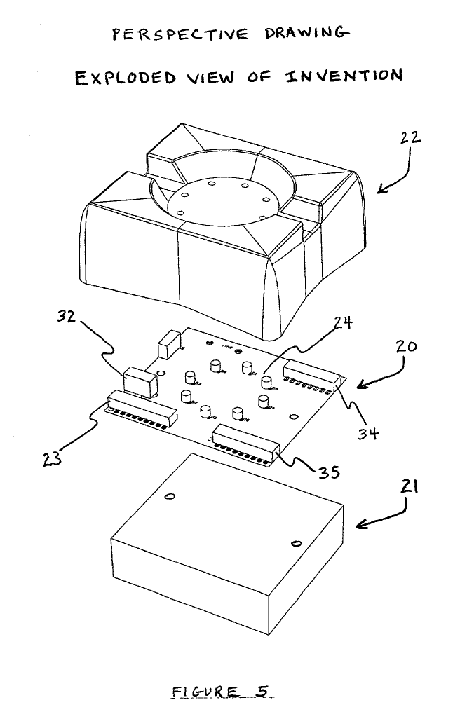

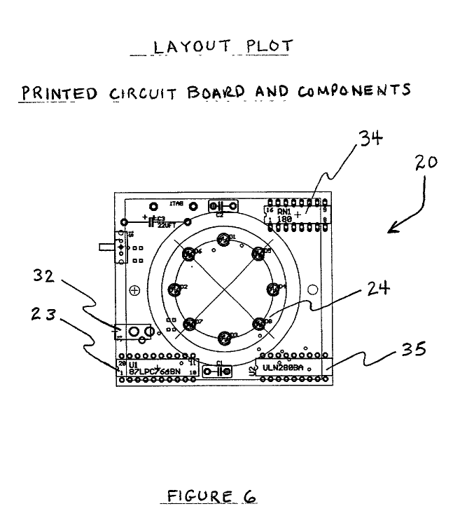

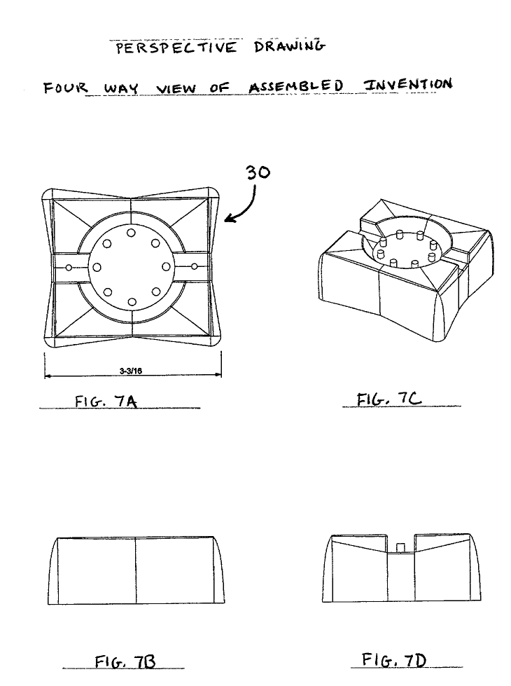

With reference to FIGS. 5 and 7, a first embodiment of the present invention will be described. The lighting system forms a device 30 which is comprised of an electronic circuit board 20, battery holder 21, and a plastic enclosure 22. The system is powered using 4 AA batteries which can be placed into the battery holder or by an external AC adapter 32 if operation is for an extended duration. Referring to FIG. 2, the electronic circuit board contains a micro-controller 23, an array of “super-bright” LED devices 24, and support electronics 25. Referring to FIG. 6, a micro-controller 23 that is suitable for this application is the Philips Semiconductor 87LPC64BN integrated circuit (IC). This is a 20 pin dip device that has two 8 bit input/output ports. One of the 8 bit ports (port 0) is used to control the LED devices. This figure also shows the support electronics which include an ULN2803A transistor driver IC 35 and a 120 ohm resistor network 34.

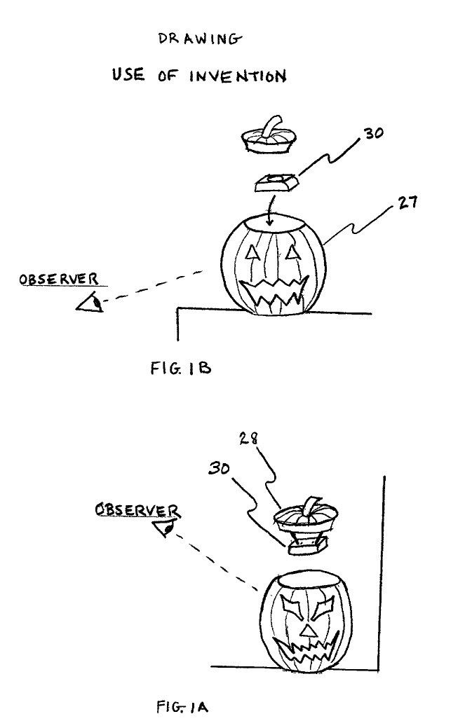

With reference to FIG. 7A, The fully assembled device 30 fits easily in the palm of one hand and is small enough to fit inside a typical carved pumpkin. Referring to FIG. 1A, to enhance the aesthetics of implementation, the apparatus should be hidden from the view of observers. To aid in this, the apparatus 30 can be placed in the bottom of a pumpkin 27 (with LED facing up). This is done when the desired presentation level of the pumpkin is higher than the observer, such as on a top shelf. Referring to FIG. 1B, the apparatus 30 can also be attached to the cut-out top 28 of a pumpkin (pinned in place with LED facing down). This is done when the presentation level of the pumpkin is lower than the observer level (such as on the floor). When the pumpkin is at an even level with the observer, it is easiest to place the apparatus in the bottom of the pumpkin.

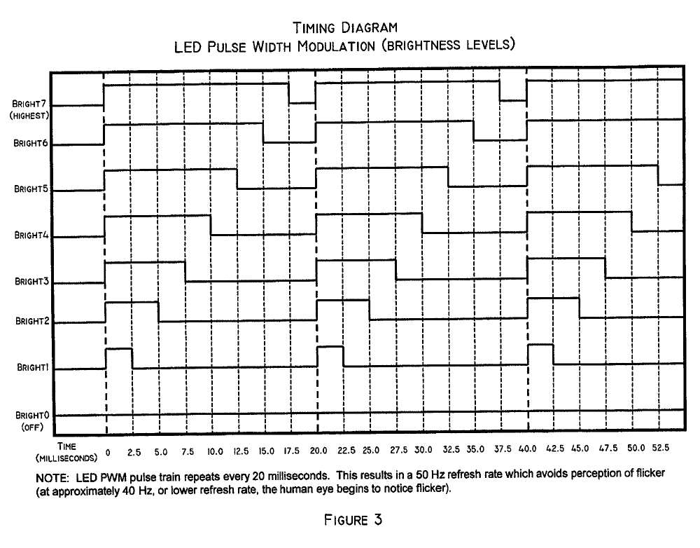

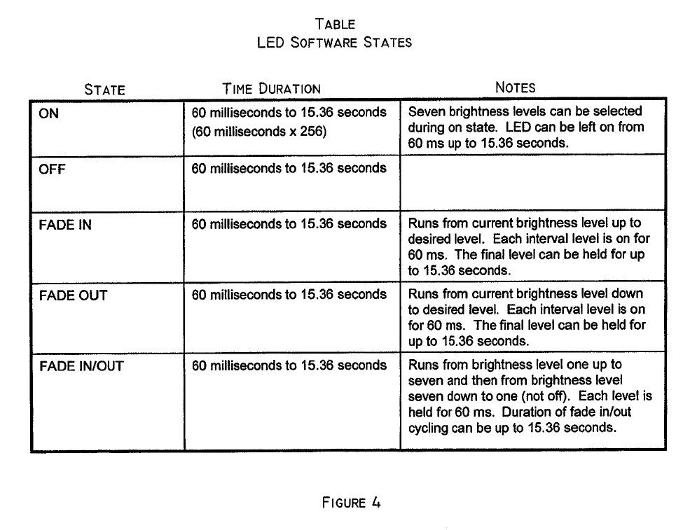

The electronic circuit board 20 contains the micro-controller 23 and software therein which controls the LED array 24 and provides for all lighting effects. The software is designed such that there are three levels of LED control. These levels are PWM, STATE, and SEQUENCE. PWM (pulse width modulation) is the first or most basic level. As shown in FIG. 3, the LED devices are energized by the micro-controller using PWM and provides for seven brightness levels. STATE is the next level of LED control, and combines the PWM pulses such that five possible LED states can exist. As shown in FIG. 4, these are ON, OFF, FADE IN, FADE OUT, and FADE IN/OUT. Finally, at the SEQUENCE, or highest level of LED software control, the five possible states are combined/sequenced together to produce the overall illumination effects for the Halloween pumpkin. Said software sequences loop continuously, the duration of which is limited by the amount of memory in the micro-controller 23. This memory length is sufficient such that the casual viewer does not perceive repeating of the lighting effects.

Referring to FIG. 3, the LED brightness is controlled using PWM to create seven ON intensity levels and an OFF state for each discrete LED. The pulse repetition rate is at 50 Hz (every 20 milliseconds). This value is chosen so as to avoid the perception of flickering by the viewer. The human eye will start to perceive flickering at approximately 40 Hz. The discrete LED colors can be mixed at various brightness levels to produce subtle variations in viewed color. As and example, red and yellow can be mixed to create orange.

The table in FIG. 4 shows an implementation of five possible software states for each LED. These states have a preferred minimum duration of 60 milliseconds; this defines the minimum time for which changes should occur in the viewed effects. If too small a time duration is implemented, too much micro-controller memory is required and the software will not make efficient use of the available memory. If too large a time duration is implemented, the LED devices will change at a slow rate, and the lighting effects will appear slow and “granular”. The 60 millisecond minimum duration is a good trade-off which provides for quick progression of illumination effects while making efficient use of micro-controller memory. Each state can be held for up to 15.36 seconds (60 milliseconds×256).

The highest level of software control is the sequencing together of the LED states to provide the perceptible illumination effects for the Halloween pumpkin. One desirable effect for a pumpkin is a realistic, “non-electronic” simulation of a traditional candle. This can be accomplished by energizing yellow and red LED colors simultaneously, and using software sequencing to produce smooth fade in, fade out, and “flickering” (on/off) of the LED colors. Referring to FIG. 6, the LED devices 24 are spatially separated. The spatial separation of the LED devices enhances the candle effect by providing subtle shadowing on the face of the carved pumpkin much like the moving flame of a real burning candle. In this specific implementation 20, a circular pattern of 1.25 inches in diameter is utilized with the LED devices 24 being centered along the circumference of the circle. The LED devices 24 are placed in alternating red and yellow colors.

Software sequencing combines the simulated candle effect with other more pronounced artificial effects. These effects can include flashing of pure LED colors, and illumination themes such as a “heart-beat” (flashing red heart-beat) and “lightning” (flashing LED devices simulating natural lightning). A “patriotic” theme can also be implemented by sequencing red, white, and blue LED devices. The micro-controller 23 software sequences the various lighted themes, and repeats them continuously; this is the complete operation of the decorative apparatus. Referring to FIG. 1B, the full embodiment of the invention when used for decoration is the placement of the decorative lighting apparatus 30 inside a natural or artificial pumpkin 27. If the pumpkin has been carved, the carving will be illuminated from behind by the lighting apparatus 30. Thin walled pumpkins will also appear to glow from inside as light will show through the skin of the pumpkin.

1. A decorative lighting display apparatus for use within a pumpkin:
having an array of multi-color lighted devices for illumination;
and a component for controlling said devices by sequencing off state, on state, on state color selection, on state intensity level, and duration thereof.

2. The lighting apparatus of claim 1, wherein said illumination devices are comprised of light emitting diodes (LED), incandescent bulbs, neon bulbs, florescent bulbs, or laser.

3. The lighting apparatus of claim 1, wherein said light state sequencing is accomplished through the use of micro-processor or micro-controller and execution of software therein.

4. The lighting apparatus of claim 1, wherein said light state sequencing is accomplished through the use of electronic hardware counter, timer, state-machine or other forms of electronic hardware control.

5. The light state sequencing of claim 3, where said state sequences are combined and executed to produce various light color themes which include “candle flicker”, “lightning”, red “heart-beat”, red/white/blue “patriotic”.

6. The light state sequencing of claim 4, where said state sequences are combined and executed to produce various light color themes which include “candle flicker”, “lightning”, red “heart-beat”, red/white/blue “patriotic”.

7. The lighting apparatus of claim 1, where said array of illuminating devices are spatially separated and under precise intensity control such that subtle shadowing effects can be produced on the face of the carved pumpkin.

8. The lighting apparatus of claim 1, wherein the apparatus further comprises a natural pumpkin, artificial pumpkin, or pumpkin like product.

9. The lighting apparatus of claim 1, wherein said state sequencing is displayed in pseudo-random order or repeated in loop.

10. A decorative lighting display apparatus for the interior illumination of a pumpkin comprised of an electronic circuit board containing multi-color LED illumination devices, battery holder, and enclosure.

11. The lighting apparatus of claim 10, where said apparatus is of size so as to fit inside a typical carved pumpkin.

12. The lighting apparatus of claim 10, where said LED devices protrude through the top of the enclosure and are positioned in a geometric pattern.

13. A method for illuminating the interior of a pumpkin with a plurality of multi-colored light sources comprising the steps of:
energizing light sources such that the simulation of natural light effects and artificial light effects are displayed;
and sequencing the effects in pseudo random order or repeating in loop.
